(19) United States
(12) Patent Application Publication
(10) Pub. No.: US 2023/0351003 A1
(43) Pub. Date: Nov. 2, 2023

(54) Preventing Exposure of Video Conference Media to Unauthorized Persons

(71) Applicant: Zoom Video Communications, Inc., San Jose, CA (US)

(72) Inventor: Shane Paul Springer, Manchester, MI (US)

(21) Appl. No.: 17/732,991

(22) Filed: Apr. 29, 2022

(51) Int. Cl. G06F 21/44; H04L 65/403; G06V 40/16

(52) U.S. Cl. CPC G06F 21/44; H04L 65/403; G06V 40/172

(57) ABSTRACT

One or more actions are performed to prevent exposure of media of a video conference to an unauthorized person who, during the video conference, enters a physical space from which one or more conference participants are attending the video conference. The one or more actions correspond to modifications to the media of the video conference output at one or more devices within the physical space and may, for example, include blurring video content of the video conference and/or distorting audio content of the video conference. Based on a resolution event associated with the unauthorized person, such as a conference participant authorizing access to the conference by the unauthorized person or a determination that the unauthorized person has left the physical space, the media of the video conference may be restored at the one or more devices within the physical space.

### FIELD

This disclosure generally relates to conference security, and, more specifically, to preventing exposure of media of a conference (e.g., a video conference) to an unauthorized person.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of an electronic computing and communications system.

FIG. 2 is a block diagram of an example internal configuration of a computing device of an electronic computing and communications system.

FIG. 3 is a block diagram of an example of a software platform implemented by an electronic computing and communications system.

FIG. 4 is a block diagram of an example of a conferencing system for delivering conferencing software services in an electronic computing and communications system.

FIG. 5 is a block diagram of an example of a system for preventing exposure of media of a conference to an unauthorized person.

FIGS. 6A-B are illustrations of examples of physical spaces and unauthorized persons determined to have entered same.

FIGS. 7A-B are swim lane diagrams of example sequences of operations performed for preventing exposure of media of a conference to an unauthorized person.

FIG. 8 is a flowchart of an example of a technique for preventing exposure of media of a conference to an unauthorized person.

### DETAILED DESCRIPTION

Conferencing software is frequently used across various industries to support audio and/or video conferences between participants in multiple locations. In many cases, one or more of the conference participants is physically located in and connects to the conferencing software from a physical space (e.g., a conference room, an office, or a classroom), and other conference participants connect to the conferencing software from one or more remote locations. Conferencing software thus enables people to conduct conferences without requiring them to be physically present with one another. Conferencing software may be available as a standalone software product or it may be integrated within a software platform, such as a unified communications as a service (UCaaS) platform.

The physical space from which one or more conference participants attend a conference may be a shared physical space which is not generally available for their exclusive use. For example, a conference room may be reserved as a physical space for a conference to support multiple conference participants attending from the conference room. In some cases, a person who is not an authorized participant of the conference (i.e., an unauthorized person) may enter the physical space during the conference, such as to share messages with one or more of the conference participants within the physical space, to deliver catered food to the conference participants, or because they intended to enter a different physical space and accidentally entered the wrong one. While in the physical space, such an unauthorized person may be exposed to media of the conference (e.g., audio and/or video output via the conferencing software, such as screen share content, audio of participant discussions, or digital whiteboard content). Where that media is confidential or otherwise sensitive, the exposure of the media to the unauthorized person creates a security issue for the conference participants.

Conventional conferencing software systems do not include mitigation systems for preventing exposure of conference content to an unauthorized person. As such, available solutions for conference participants within the physical space to attempt to mitigate against exposure of conference media to an unauthorized person include temporarily muting and/or turning off a display of a device connected to the conference or asking other conference participants to temporarily refrain from sharing further media while the unauthorized person is present. However, these solutions suffer several drawbacks. First, they are disruptive to the conference in that they are highly likely to interrupt conversations or presentations. Second, they are unnecessarily overreaching in that they may require participants not in the physical space to temporarily stop discussions amongst themselves. Finally, they may be ineffective in that it may take too long for a conference participant to recognize that an unauthorized person is present and perform a mitigation action.

Implementations of this disclosure address problems such as these by preventing exposure of media of a conference (e.g., a video conference) to an unauthorized person who, during the conference, enters a physical space from which one or more conference participants are attending the conference. A determination is made that the unauthorized person has entered the physical space, for example, based on a video stream captured by a camera within the physical space depicting the unauthorized person or based on a sensor external to the physical space detecting the unauthorized person in a position at which media of the conference may be perceptible. Based on the determination that the unauthorized person has entered the physical space, media of the video conference output at one or more devices within the physical space is modified, for example, by blurring video content of the video conference and/or distorting audio content of the video conference, or by suspending output of the video content and/or the audio content. Based on a resolution event associated with the unauthorized person, such as a conference participant authorizing access to the conference by the unauthorized person or a determination that the unauthorized person has left the physical space, the media of the video conference may be restored at the one or more devices within the physical space. The modification of the media enhances conference security by preventing exposure to the media by the unauthorized person without unnecessarily disrupting the conference.

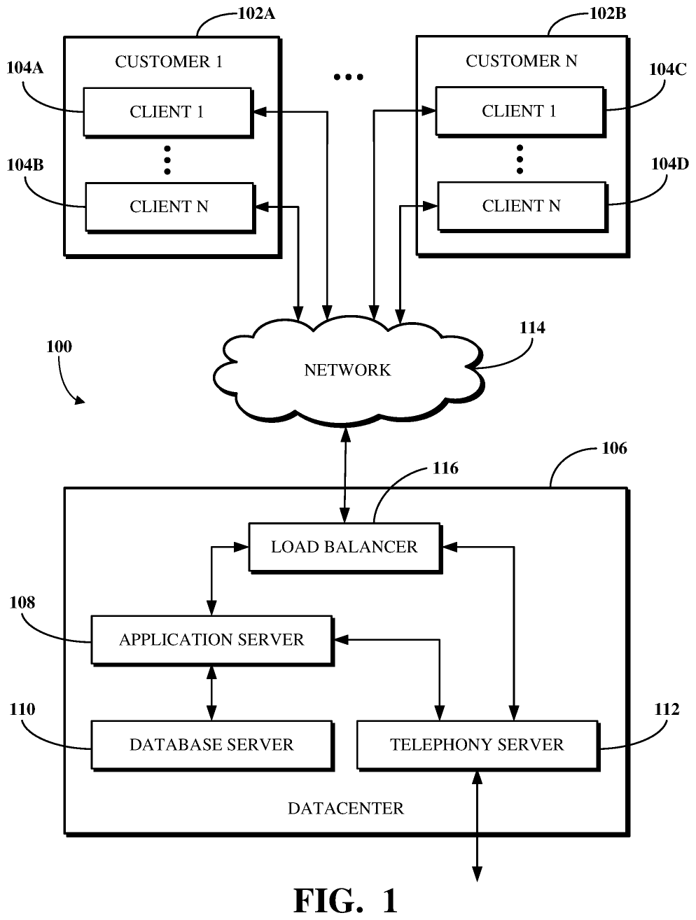

To describe some implementations in greater detail, reference is first made to examples of hardware and software structures used to implement a system for preventing exposure of media of a conference to an unauthorized person. FIG. 1 is a block diagram of an example of an electronic computing and communications system 100, which can be or include a distributed computing system (e.g., a client-server computing system), a cloud computing system, a clustered computing system, or the like.

The system 100 includes one or more customers, such as customers 102A through 102B, which may each be a public entity, private entity, or another corporate entity or individual that purchases or otherwise uses software services, such as of a UCaaS platform provider. Each customer can include one or more clients. For example, as shown and without limitation, the customer 102A can include clients 104A through 104B, and the customer 102B can include clients 104C through 104D. A customer can include a customer network or domain. For example, and without limitation, the clients 104A through 104B can be associated or communicate with a customer network or domain for the customer 102A and the clients 104C through 104D can be associated or communicate with a customer network or domain for the customer 102B.

A client, such as one of the clients 104A through 104D, may be or otherwise refer to one or both of a client device or a client application. Where a client is or refers to a client device, the client can comprise a computing system, which can include one or more computing devices, such as a mobile phone, a tablet computer, a laptop computer, a notebook computer, a desktop computer, or another suitable computing device or combination of computing devices. Where a client instead is or refers to a client application, the client can be an instance of software running on a customer device (e.g., a client device or another device). In some implementations, a client can be implemented as a single physical unit or as a combination of physical units. In some implementations, a single physical unit can include multiple clients.

The system 100 can include a number of customers and/or clients or can have a configuration of customers or clients different from that generally illustrated in FIG. 1. For example, and without limitation, the system 100 can include hundreds or thousands of customers, and at least some of the customers can include or be associated with a number of clients.

The system 100 includes a datacenter 106, which may include one or more servers. The datacenter 106 can represent a geographic location, which can include a facility, where the one or more servers are located. The system 100 can include a number of datacenters and servers or can include a configuration of datacenters and servers different from that generally illustrated in FIG. 1. For example, and without limitation, the system 100 can include tens of datacenters, and at least some of the datacenters can include hundreds or another suitable number of servers. In some implementations, the datacenter 106 can be associated or communicate with one or more datacenter networks or domains, which can include domains other than the customer domains for the customers 102A through 102B.

The datacenter 106 includes servers used for implementing software services of a UCaaS platform. The datacenter 106 as generally illustrated includes an application server 108, a database server 110, and a telephony server 112. The servers 108 through 112 can each be a computing system, which can include one or more computing devices, such as a desktop computer, a server computer, or another computer capable of operating as a server, or a combination thereof. A suitable number of each of the servers 108 through 112 can be implemented at the datacenter 106. The UCaaS platform uses a multi-tenant architecture in which installations or instantiations of the servers 108 through 112 is shared amongst the customers 102A through 102B.

In some implementations, one or more of the servers 108 through 112 can be a non-hardware server implemented on a physical device, such as a hardware server. In some implementations, a combination of two or more of the application server 108, the database server 110, and the telephony server 112 can be implemented as a single hardware server or as a single non-hardware server implemented on a single hardware server. In some implementations, the datacenter 106 can include servers other than or in addition to the servers 108 through 112, for example, a media server, a proxy server, or a web server.

The application server 108 runs web-based software services deliverable to a client, such as one of the clients 104A through 104D. As described above, the software services may be of a UCaaS platform. For example, the application server 108 can implement all or a portion of a UCaaS platform, including conferencing software, messaging software, and/or other intra-party or inter-party communications software. The application server 108 may, for example, be or include a unitary Java Virtual Machine (JVM).

In some implementations, the application server 108 can include an application node, which can be a process executed on the application server 108. For example, and without limitation, the application node can be executed in order to deliver software services to a client, such as one of the clients 104A through 104D, as part of a software application. The application node can be implemented using processing threads, virtual machine instantiations, or other computing features of the application server 108. In some such implementations, the application server 108 can include a suitable number of application nodes, depending upon a system load or other characteristics associated with the application server 108. For example, and without limitation, the application server 108 can include two or more nodes forming a node cluster. In some such implementations, the application nodes implemented on a single application server 108 can run on different hardware servers.

The database server 110 stores, manages, or otherwise provides data for delivering software services of the application server 108 to a client, such as one of the clients 104A through 104D. In particular, the database server 110 may implement one or more databases, tables, or other information sources suitable for use with a software application implemented using the application server 108. The database server 110 may include a data storage unit accessible by software executed on the application server 108. A database implemented by the database server 110 may be a relational database management system (RDBMS), an object database, an XML database, a configuration management database (CMDB), a management information base (MIB), one or more flat files, other suitable non-transient storage mechanisms, or a combination thereof. The system 100 can include one or more database servers, in which each database server can include one, two, three, or another suitable number of databases configured as or comprising a suitable database type or combination thereof.

In some implementations, one or more databases, tables, other suitable information sources, or portions or combinations thereof may be stored, managed, or otherwise provided by one or more of the elements of the system 100 other than the database server 110, for example, the client 104 or the application server 108.

The telephony server 112 enables network-based telephony and web communications from and to clients of a customer, such as the clients 104A through 104B for the customer 102A or the clients 104C through 104D for the customer 102B. Some or all of the clients 104A through 104D may be voice over internet protocol (VOIP)-enabled devices configured to send and receive calls over a network 114. In particular, the telephony server 112 includes a session initiation protocol (SIP) zone and a web zone. The SIP zone enables a client of a customer, such as the customer 102A or 102B, to send and receive calls over the network 114 using SIP requests and responses. The web zone integrates telephony data with the application server 108 to enable telephony-based traffic access to software services run by the application server 108. Given the combined functionality of the SIP zone and the web zone, the telephony server 112 may be or include a cloud-based private branch exchange (PBX) system.

The SIP zone receives telephony traffic from a client of a customer and directs same to a destination device. The SIP zone may include one or more call switches for routing the telephony traffic. For example, to route a VOIP call from a first VOIP-enabled client of a customer to a second VOIP-enabled client of the same customer, the telephony server 112 may initiate a SIP transaction between a first client and the second client using a PBX for the customer. However, in another example, to route a VOIP call from a VOIP-enabled client of a customer to a client or non-client device (e.g., a desktop phone which is not configured for VOIP communication) which is not VOIP-enabled, the telephony server 112 may initiate a SIP transaction via a VOIP gateway that transmits the SIP signal to a public switched telephone network (PSTN) system for outbound communication to the non-VOIP-enabled client or non-client phone. Hence, the telephony server 112 may include a PSTN system and may in some cases access an external PSTN system.

The telephony server 112 includes one or more session border controllers (SBCs) for interfacing the SIP zone with one or more aspects external to the telephony server 112. In particular, an SBC can act as an intermediary to transmit and receive SIP requests and responses between clients or non-client devices of a given customer with clients or non-client devices external to that customer. When incoming telephony traffic for delivery to a client of a customer, such as one of the clients 104A through 104D, originating from outside the telephony server 112 is received, a SBC receives the traffic and forwards it to a call switch for routing to the client.

In some implementations, the telephony server 112, via the SIP zone, may enable one or more forms of peering to a carrier or customer premise. For example, Internet peering to a customer premise may be enabled to ease the migration of the customer from a legacy provider to a service provider operating the telephony server 112. In another example, private peering to a customer premise may be enabled to leverage a private connection terminating at one end at the telephony server 112 and at the other end at a computing aspect of the customer environment. In yet another example, carrier peering may be enabled to leverage a connection of a peered carrier to the telephony server 112.

In some such implementations, a SBC or telephony gateway within the customer environment may operate as an intermediary between the SBC of the telephony server 112 and a PSTN for a peered carrier. When an external SBC is first registered with the telephony server 112, a call from a client can be routed through the SBC to a load balancer of the SIP zone, which directs the traffic to a call switch of the telephony server 112. Thereafter, the SBC may be configured to communicate directly with the call switch.

The web zone receives telephony traffic from a client of a customer, via the SIP zone, and directs same to the application server 108 via one or more Domain Name System (DNS) resolutions. For example, a first DNS within the web zone may process a request received via the SIP zone and then deliver the processed request to a web service which connects to a second DNS at or otherwise associated with the application server 108. Once the second DNS resolves the request, it is delivered to the destination service at the application server 108. The web zone may also include a database for authenticating access to a software application for telephony traffic processed within the SIP zone, for example, a softphone.

The clients 104A through 104D communicate with the servers 108 through 112 of the datacenter 106 via the network 114. The network 114 can be or include, for example, the Internet, a local area network (LAN), a wide area network (WAN), a virtual private network (VPN), or another public or private means of electronic computer communication capable of transferring data between a client and one or more servers. In some implementations, a client can connect to the network 114 via a communal connection point, link, or path, or using a distinct connection point, link, or path. For example, a connection point, link, or path can be wired, wireless, use other communications technologies, or a combination thereof.

The network 114, the datacenter 106, or another element, or combination of elements, of the system 100 can include network hardware such as routers, switches, other network devices, or combinations thereof. For example, the datacenter 106 can include a load balancer 116 for routing traffic from the network 114 to various servers associated with the datacenter 106. The load balancer 116 can route, or direct, computing communications traffic, such as signals or messages, to respective elements of the datacenter 106.

For example, the load balancer 116 can operate as a proxy, or reverse proxy, for a service, such as a service provided to one or more remote clients, such as one or more of the clients 104A through 104D, by the application server 108, the telephony server 112, and/or another server. Routing functions of the load balancer 116 can be configured directly or via a DNS. The load balancer 116 can coordinate requests from remote clients and can simplify client access by masking the internal configuration of the datacenter 106 from the remote clients.

In some implementations, the load balancer 116 can operate as a firewall, allowing or preventing communications based on configuration settings. Although the load balancer 116 is depicted in FIG. 1 as being within the datacenter 106, in some implementations, the load balancer 116 can instead be located outside of the datacenter 106, for example, when providing global routing for multiple datacenters. In some implementations, load balancers can be included both within and outside of the datacenter 106. In some implementations, the load balancer 116 can be omitted.

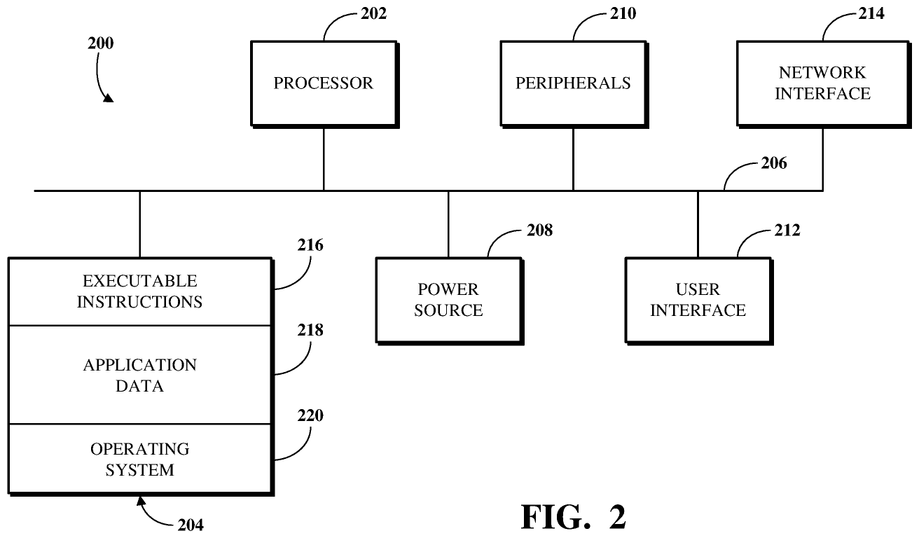

FIG. 2 is a block diagram of an example internal configuration of a computing device 200 of an electronic computing and communications system. In one configuration, the computing device 200 may implement one or more of the client 104, the application server 108, the database server 110, or the telephony server 112 of the system 100 shown in FIG. 1.

The computing device 200 includes components or units, such as a processor 202, a memory 204, a bus 206, a power source 208, peripherals 210, a user interface 212, a network interface 214, other suitable components, or a combination thereof. One or more of the memory 204, the power source 208, the peripherals 210, the user interface 212, or the network interface 214 can communicate with the processor 202 via the bus 206.

The processor 202 is a central processing unit, such as a microprocessor, and can include single or multiple processors having single or multiple processing cores. Alternatively, the processor 202 can include another type of device, or multiple devices, configured for manipulating or processing information. For example, the processor 202 can include multiple processors interconnected in one or more manners, including hardwired or networked. The operations of the processor 202 can be distributed across multiple devices or units that can be coupled directly or across a local area or other suitable type of network. The processor 202 can include a cache, or cache memory, for local storage of operating data or instructions.

The memory 204 includes one or more memory components, which may each be volatile memory or non-volatile memory. For example, the volatile memory can be random access memory (RAM) (e.g., a DRAM module, such as DDR SDRAM). In another example, the non-volatile memory of the memory 204 can be a disk drive, a solid state drive, flash memory, or phase-change memory. In some implementations, the memory 204 can be distributed across multiple devices. For example, the memory 204 can include network-based memory or memory in multiple clients or servers performing the operations of those multiple devices.

The memory 204 can include data for immediate access by the processor 202. For example, the memory 204 can include executable instructions 216, application data 218, and an operating system 220. The executable instructions 216 can include one or more application programs, which can be loaded or copied, in whole or in part, from non-volatile memory to volatile memory to be executed by the processor 202. For example, the executable instructions 216 can include instructions for performing some or all of the techniques of this disclosure. The application data 218 can include user data, database data (e.g., database catalogs or dictionaries), or the like. In some implementations, the application data 218 can include functional programs, such as a web browser, a web server, a database server, another program, or a combination thereof. The operating system 220 can be, for example, Microsoft Windows®, Mac OS X®, or Linux®; an operating system for a mobile device, such as a smartphone or tablet device; or an operating system for a non-mobile device, such as a mainframe computer.

The power source 208 provides power to the computing device 200. For example, the power source 208 can be an interface to an external power distribution system. In another example, the power source 208 can be a battery, such as where the computing device 200 is a mobile device or is otherwise configured to operate independently of an external power distribution system. In some implementations, the computing device 200 may include or otherwise use multiple power sources. In some such implementations, the power source 208 can be a backup battery.

The peripherals 210 includes one or more sensors, detectors, or other devices configured for monitoring the computing device 200 or the environment around the computing device 200. For example, the peripherals 210 can include a geolocation component, such as a global positioning system location unit. In another example, the peripherals can include a temperature sensor for measuring temperatures of components of the computing device 200, such as the processor 202. In some implementations, the computing device 200 can omit the peripherals 210.

The user interface 212 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 214 provides a connection or link to a network (e.g., the network 114 shown in FIG. 1). The network interface 214 can be a wired network interface or a wireless network interface. The computing device 200 can communicate with other devices via the network interface 214 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof.

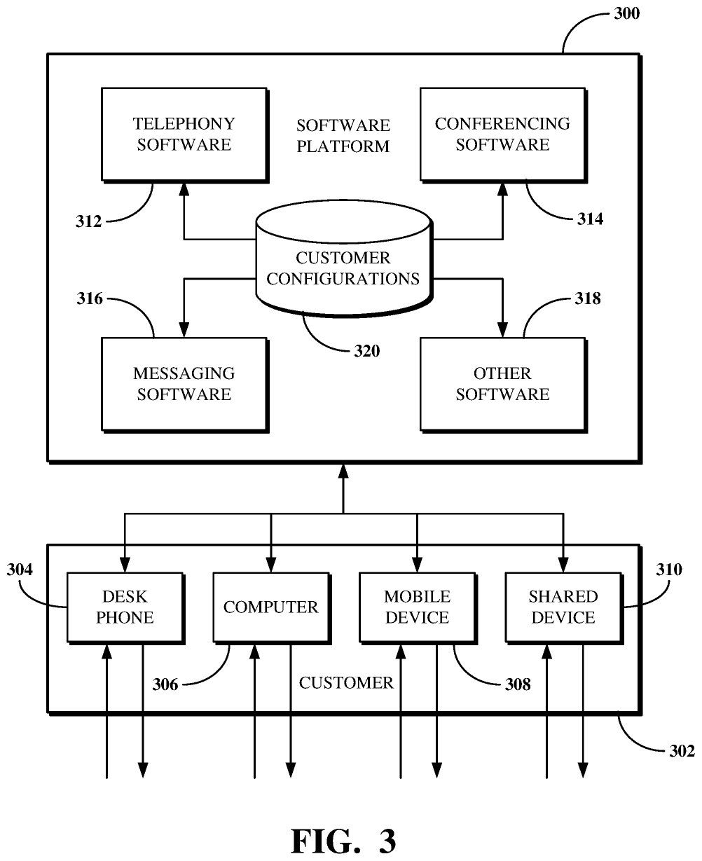

FIG. 3 is a block diagram of an example of a software platform 300 implemented by an electronic computing and communications system, for example, the system 100 shown in FIG. 1. The software platform 300 is a UCaaS platform accessible by clients of a customer of a UCaaS platform provider, for example, the clients 104A through 104B of the customer 102A or the clients 104C through 104D of the customer 102B shown in FIG. 1. The software platform 300 may be a multi-tenant platform instantiated using one or more servers at one or more datacenters including, for example, the application server 108, the database server 110, and the telephony server 112 of the datacenter 106 shown in FIG. 1.

The software platform 300 includes software services accessible using one or more clients. For example, a customer 302 as shown includes four clients—a desk phone 304, a computer 306, a mobile device 308, and a shared device 310. The desk phone 304 is a desktop unit configured to at least send and receive calls and includes an input device for receiving a telephone number or extension to dial to and an output device for outputting audio and/or video for a call in progress. The computer 306 is a desktop, laptop, or tablet computer including an input device for receiving some form of user input and an output device for outputting information in an audio and/or visual format. The mobile device 308 is a smartphone, wearable device, or other mobile computing aspect including an input device for receiving some form of user input and an output device for outputting information in an audio and/or visual format. The desk phone 304, the computer 306, and the mobile device 308 may generally be considered personal devices configured for use by a single user. The shared device 310 is a desk phone, a computer, a mobile device, or a different device which may instead be configured for use by multiple specified or unspecified users.

Each of the clients 304 through 310 includes or runs on a computing device configured to access at least a portion of the software platform 300. In some implementations, the customer 302 may include additional clients not shown. For example, the customer 302 may include multiple clients of one or more client types (e.g., multiple desk phones or multiple computers) and/or one or more clients of a client type not shown in FIG. 3 (e.g., wearable devices or televisions other than as shared devices). For example, the customer 302 may have tens or hundreds of desk phones, computers, mobile devices, and/or shared devices.

The software services of the software platform 300 generally relate to communications tools, but are in no way limited in scope. As shown, the software services of the software platform 300 include telephony software 312, conferencing software 314, messaging software 316, and other software 318. Some or all of the software 312 through 318 uses customer configurations 320 specific to the customer 302. The customer configurations 320 may, for example, be data stored within a database or other data store at a database server, such as the database server 110 shown in FIG. 1.

The telephony software 312 enables telephony traffic between ones of the clients 304 through 310 and other telephony-enabled devices, which may be other ones of the clients 304 through 310, other VOIP-enabled clients of the customer 302, non-VOIP-enabled devices of the customer 302, VOIP-enabled clients of another customer, non-VOIP-enabled devices of another customer, or other VOIP-enabled clients or non-VOIP-enabled devices. Calls sent or received using the telephony software 312 may, for example, be sent or received using the desk phone 304, a softphone running on the computer 306, a mobile application running on the mobile device 308, or using the shared device 310 that includes telephony features.

The telephony software 312 further enables phones that do not include a client application to connect to other software services of the software platform 300. For example, the telephony software 312 may receive and process calls from phones not associated with the customer 302 to route that telephony traffic to one or more of the conferencing software 314, the messaging software 316, or the other software 318.

The conferencing software 314 enables audio, video, and/or other forms of conferences between multiple participants, such as to facilitate a conference between those participants. In some cases, the participants may all be physically present within a single location, for example, a conference room, in which the conferencing software 314 may facilitate a conference between only those participants and using one or more clients within the conference room. In some cases, one or more participants may be physically present within a single location and one or more other participants may be remote, in which the conferencing software 314 may facilitate a conference between all of those participants using one or more clients within the conference room and one or more remote clients. In some cases, the participants may all be remote, in which the conferencing software 314 may facilitate a conference between the participants using different clients for the participants. The conferencing software 314 can include functionality for hosting, presenting scheduling, joining, or otherwise participating in a conference. The conferencing software 314 may further include functionality for recording some or all of a conference and/or documenting a transcript for the conference.

The messaging software 316 enables instant messaging, unified messaging, and other types of messaging communications between multiple devices, such as to facilitate a chat or other virtual conversation between users of those devices. The unified messaging functionality of the messaging software 316 may, for example, refer to email messaging which includes a voicemail transcription service delivered in email format.

The other software 318 enables other functionality of the software platform 300. Examples of the other software 318 include, but are not limited to, device management software, resource provisioning and deployment software, administrative software, third party integration software, and the like. In one particular example, the other software 318 can include conference security software for preventing exposure of media of a conference (e.g., a video conference) to an unauthorized person. In some such cases, the other software 318 may be or be included in the conferencing software 314.

The software 312 through 318 may be implemented using one or more servers, for example, of a datacenter such as the datacenter 106 shown in FIG. 1. For example, one or more of the software 312 through 318 may be implemented using an application server, a database server, and/or a telephony server, such as the servers 108 through 112 shown in FIG. 1. In another example, one or more of the software 312 through 318 may be implemented using servers not shown in FIG. 1, for example, a meeting server, a web server, or another server. In yet another example, one or more of the software 312 through 318 may be implemented using one or more of the servers 108 through 112 and one or more other servers. The software 312 through 318 may be implemented by different servers or by the same server.

Features of the software services of the software platform 300 may be integrated with one another to provide a unified experience for users. For example, the messaging software 316 may include a user interface element configured to initiate a call with another user of the customer 302. In another example, the telephony software 312 may include functionality for elevating a telephone call to a conference. In yet another example, the conferencing software 314 may include functionality for sending and receiving instant messages between participants and/or other users of the customer 302. In yet another example, the conferencing software 314 may include functionality for file sharing between participants and/or other users of the customer 302. In some implementations, some or all of the software 312 through 318 may be combined into a single software application run on clients of the customer, such as one or more of the clients 304 through 310.

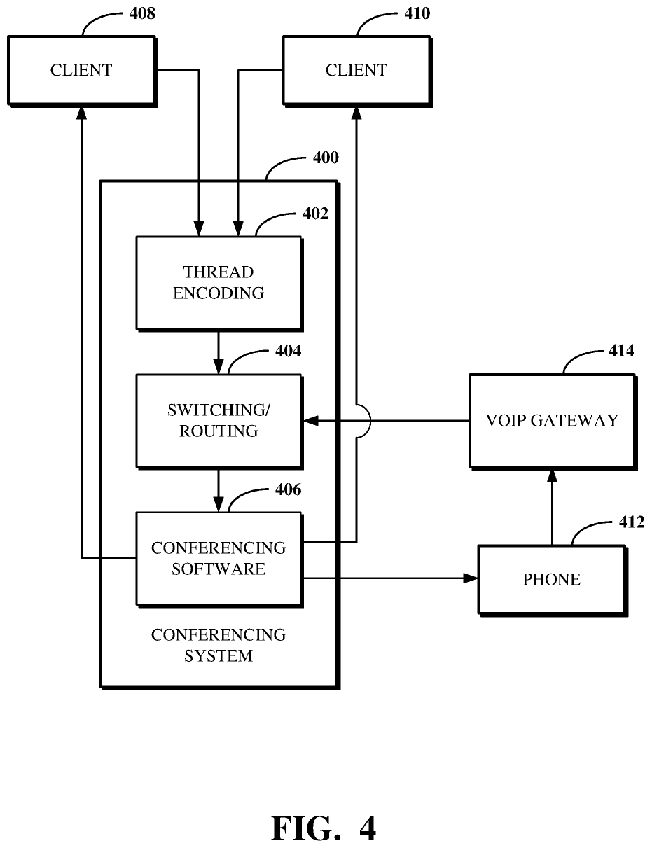

FIG. 4 is a block diagram of an example of a conferencing system 400 for delivering conferencing software services in an electronic computing and communications system, for example, the system 100 shown in FIG. 1. The conferencing system 400 includes a thread encoding tool 402, a switching/routing tool 404, and conferencing software 406. The conferencing software 406, which may, for example, be the conferencing software 314 shown in FIG. 3, is software for implementing conferences (e.g., video conferences) between users of clients and/or phones, such as clients 408 and 410 and phone 412. For example, the clients 408 or 410 may each be one of the clients 304 through 310 shown in FIG. 3 that runs a client application associated with the conferencing software 406, and the phone 412 may be a telephone which does not run a client application associated with the conferencing software 406 or otherwise access a web application associated with the conferencing software 406. The conferencing system 400 may in at least some cases be implemented using one or more servers of the system 100, for example, the application server 108 shown in FIG. 1. Although two clients and a phone are shown in FIG. 4, other numbers of clients and/or other numbers of phones can connect to the conferencing system 400.

Implementing a conference includes transmitting and receiving video, audio, and/or other data between clients and/or phones, as applicable, of the conference participants. Each of the client 408, the client 410, and the phone 412 may connect through the conferencing system 400 using separate input streams to enable users thereof to participate in a conference together using the conferencing software 406. The various channels used for establishing connections between the clients 408 and 410 and the phone 412 may, for example, be based on the individual device capabilities of the clients 408 and 410 and the phone 412.

The conferencing software 406 includes a user interface tile for each input stream received and processed at the conferencing system 400. A user interface tile as used herein generally refers to a portion of a conferencing software user interface which displays information (e.g., a rendered video) associated with one or more conference participants. A user interface tile may, but need not, be generally rectangular. The size of a user interface tile may depend on one or more factors including the view style set for the conferencing software user interface at a given time and whether the one or more conference participants represented by the user interface tile are active speakers at a given time. The view style for the conferencing software user interface, which may be uniformly configured for all conference participants by a host of the subject conference or which may be individually configured by each conference participant, may be one of a gallery view in which all user interface tiles are similarly or identically sized and arranged in a generally grid layout or a speaker view in which one or more user interface tiles for active speakers are enlarged and arranged in a center position of the conferencing software user interface while the user interface tiles for other conference participants are reduced in size and arranged near an edge of the conferencing software user interface.

The content of the user interface tile associated with a given participant may be dependent upon the source of the input stream for that participant. For example, where a participant accesses the conferencing software 406 from a client, such as the client 408 or 410, the user interface tile associated with that participant may include a video stream captured at the client and transmitted to the conferencing system 400, which is then transmitted from the conferencing system 400 to other clients for viewing by other participants (although the participant may optionally disable video features to suspend the video stream from being presented during some or all of the conference). In another example, where a participant accesses the conferencing software 406 from a phone, such as the phone 412, the user interface tile for the participant may be limited to a static image showing text (e.g., a name, telephone number, or other identifier associated with the participant or the phone 412) or other default background aspect since there is no video stream presented for that participant.

The thread encoding tool 402 receives video streams separately from the clients 408 and 410 and encodes those video streams using one or more transcoding tools, such as to produce variant streams at different resolutions. For example, a given video stream received from a client may be processed using multi-stream capabilities of the conferencing system 400 to result in multiple resolution versions of that video stream, including versions at 90p, 180p, 360p, 720p, and/or 1080p, amongst others. The video streams may be received from the clients over a network, for example, the network 114 shown in FIG. 1, or by a direct wired connection, such as using a universal serial bus (USB) connection or like coupling aspect. After the video streams are encoded, the switching/routing tool 404 directs the encoded streams through applicable network infrastructure and/or other hardware to deliver the encoded streams to the conferencing software 406. The conferencing software 406 transmits the encoded video streams to each connected client, such as the clients 408 and 410, which receive and decode the encoded video streams to output the video content thereof for display by video output components of the clients, such as within respective user interface tiles of a user interface of the conferencing software 406.

A user of the phone 412 participates in a conference using an audio-only connection and may be referred to an audio-only caller. To participate in the conference from the phone 412, an audio signal from the phone 412 is received and processed at a VOIP gateway 414 to prepare a digital telephony signal for processing at the conferencing system 400. The VOIP gateway 414 may be part of the system 100, for example, implemented at or in connection with a server of the datacenter 106, such as the telephony server 112 shown in FIG. 1. Alternatively, the VOIP gateway 414 may be located on the user-side, such as in a same location as the phone 412. The digital telephony signal is a packet switched signal transmitted to the switching/routing tool 404 for delivery to the conferencing software 406. The conferencing software 406 outputs an audio signal representing a combined audio capture for each participant of the conference for output by an audio output component of the phone 412. In some implementations, the VOIP gateway 414 may be omitted, for example, where the phone 412 is a VOIP-enabled phone.

A conference implemented using the conferencing software 406 may be referred to as a video conference in which video streaming is enabled for the conference participants thereof. The enabling of video streaming for a conference participant of a video conference does not require that the conference participant activate or otherwise use video functionality for participating in the video conference. For example, a conference may still be a video conference where none of the participants joining using clients turns on their video feed for any portion of the conference. In some cases, however, the conference may have video disabled, such as where each participant connects to the conference using a phone rather than a client, or where a host of the conference selectively configures the conference to exclude video functionality.

In some implementations, other software services may be accessible in connection with a conference implemented using the conferencing system 400. For example, a conference may include or otherwise integrate functionality for instant messaging, unified messaging, and other types of messaging communications between participants of the conference, such as to facilitate a chat or like virtual conversation between users of those participants. Those other software services may be implemented at the conferencing system 400 and/or a different aspect of the system 100.

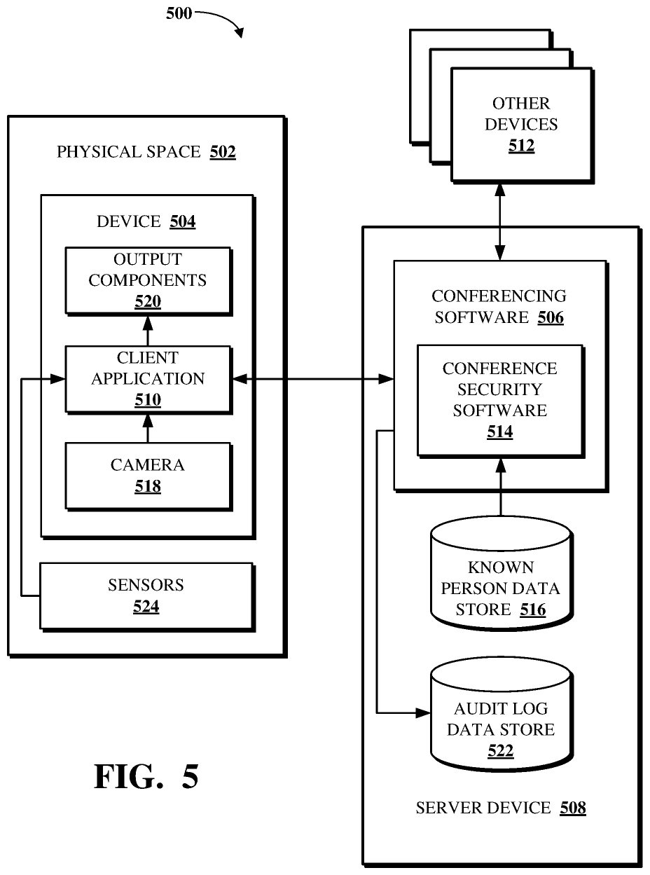

FIG. 5 is a block diagram of an example of a system 500 for preventing exposure of media of a conference to an unauthorized person. The system 500 includes one or more devices located within a physical space 502 from which one or more conference participants may attend a conference, such as a video conference. The physical space 502 may, for example, be a conference room, an office, a classroom, a lecture hall, an event hall, a passenger compartment of a vehicle (e.g., a bus, train, boat, or airplane), or a room within a residence (e.g., a kitchen or living room). In the example shown, the one or more devices located within the physical space include a device 504. The device 504 is a client device, for example, one of the clients 304 through 310 shown in FIG. 3, configured to connect to a conference implemented by conferencing software 506 at a server device 508 via a client application 510. The conferencing software 510 may, for example, be the conferencing software 406 shown in FIG. 4. The conferencing software 510 may, for example, be a software service of a software platform, such as the software platform 300 shown in FIG. 3. The server device 508 may, for example, be the application server 108 shown in FIG. 1. One or more conference participants located within the physical space 502 and attending the conference implemented using the conferencing software 506 may communicate via the conference with one or more other conference participants connecting to the conference using one or more other devices 512 located in one or more locations external to the physical space 502. Each of the one or more other devices 512 may, for example, be a client, such as one of the clients 304 through 310.

The conference implemented by the conferencing software 506 may be an audio-only conference (i.e., in which no video media is provided), a video-only conference (i.e., in which no audio media is provided), or an audio and video conference (collectively referred to as a “video conference”). The audio content of an audio-only conference or of a video conference may, for example, include audio captured by microphones of participant devices (e.g., the device 504 and the other devices 512) and/or audio shared from one or more of the participant devices with the other participant devices (e.g., streamed audio or audio from a local file, such as music or an audio channel of other media). The video content of a video-only conference or of a video conference may, for example, include video captured by cameras of participant devices (e.g., the device 504 and the other devices 512) and/or video shared from one or more of the participant devices with the other participant devices (e.g., streamed images or video or images or video from a local file, such as a slideshow presentation or a video channel of a movie). For example, in some cases, a video-only conference or a video conference may be limited to screen share content presented from one of the participant devices to the other participant devices.

The conferencing software 506 includes conference security software 514. The conference security software 514 includes tools, such as programs, subprograms, functions, routines, subroutines, operations, and/or the like for preventing exposure of media of a conference to an unauthorized person. The conference security software 514 processes information obtained from the client application 510 to determine that an unauthorized person has entered the physical space 502 and to modify media output at the device 504 based on the determination that the unauthorized person has entered the physical space 502. The unauthorized person is a person who is not included in a list of authorized participants associated with the conference. For example, the list of authorized participants may include or otherwise refer to conference metadata and/or calendar metadata indicative of one or more persons who were invited to attend the conference. The conference security software 514 may determine that the unauthorized person has entered the physical space 502 by identifying the unauthorized person based on the information obtained from the client application 510 and a known person data store 516, and by thereafter comparing identifying information of the unauthorized person against the list of authorized participants for the conference.

The information obtained from the client application 510 and used by the conference security software 514 to determine that the unauthorized person has entered the physical space can include or otherwise refer to a video stream captured using a camera 518 of or otherwise associated with the device 504. For example, the camera 518 may be a camera integrated within the device 504 or a camera coupled to the device 504 via wired or wireless connection. In some cases, where the device 504 includes multiple integrated cameras (e.g., a front facing camera and a rear facing camera) or has multiple cameras coupled thereto, the camera 518 may include or otherwise refer to multiple cameras, and the video stream included or otherwise referred to by the information obtained from the client application 510 can include one or more video streams captured by one or more of the multiple cameras. In particular, the client application 510 transmits a video stream captured using the camera 518 to the conferencing software 506 for processing and rendering within a user interface tile associated with the device 504 (or, in some cases, multiple user interface tiles, such as where the video stream is processed to produce multiple video streams cropped to specific participants within the physical space which are then output to their own user interface tiles).

The known person data store 516 is a database or other data store configured for storing information associated with people known to the system 500. For example, where the system 500 is implemented in connection with a business enterprise (e.g., in which the conferencing software 506 is used by the business enterprise as a customer of the software platform), the known person data store 516 may store information associated with employees, contractors, and other workers or known associates (e.g., visitors) of the business enterprise. In another example, where the system 500 is implemented in connection with a school (e.g., in which the conferencing software 506 is used by the school as a customer of the software platform), the known person data store 516 may store information associated with students, teachers, administrators, and other faculty or known associates (e.g., school board members or chaperones). The information associated with a person stored in the known person data store 516 includes identifying information usable to identify the person. For example, the information associated with a person stored in the known person data store 516 may include a name of the person, a picture of a face of the person (e.g., an employee badge photo or a photo from a government-issued id card), contact information of the person (e.g., an email address or telephone number), biometric information of the person (e.g., fingerprint data or iris data), or registration information (e.g., an alphanumeric code or other identifier associated with the person).

The conference security software 514 processes the information obtained from the device 504 against the information stored within the known person data store 516 to determine identifying information for an unauthorized person determined to have entered the physical space 502. For example, the conference security software 514 may perform facial detection against a video stream captured by the camera 518 (e.g., as the information obtained from the device 504), or cause facial recognition to be performed against same (e.g., where the facial detection processing is performed other than by the conference security software 514) to detect one or more faces within the video stream. The conference security software 514 may then perform facial recognition against some or all of the video stream (e.g., portions of video frames of the video stream in which the faces are detected) based on the detected faces using the known person data store 516 by searching the known person data store for pictures corresponding to the detected faces. Identifying information (e.g., names and/or email addresses) for the persons corresponding to the detected faces may then be obtained based on that comparison and compared against the list of authorized participants for the conference. The unauthorized person may be determined as a person corresponding to identifying information not included in the list of authorized participants.

In some implementations, the conference security software 514 can determine that the unauthorized person has entered the physical space 502 during the conference based on a matching of other detected faces to the authorized participants on the list of authorized participants. For example, the conference security software 514 may at some point during the conference determine that a number of faces detected within the video stream captured by the camera 518 matches the number of authorized participants within the list of authorized participants and that each of the detected faces, based on a facial recognition process as disclosed herein, corresponds to one such person on the list of authorized participants. The conference security software 514 thus determines that all conference participants on the list of authorized participants have been identified. When a new person is detected, such as via the facial detection and recognition processes disclosed herein, the conference security software 514 references its earlier determination that all conference participants on the list of authorized participants have been identified to infer that the new person is an unauthorized person.

Based on the determination that the unauthorized person has entered the physical space 502 (e.g., based on the identification of the unauthorized person), media of the conference output at the device 504 is modified. For example, the media may include video content and/or audio content of the conference. In some cases, the modification may include blurring or suspending video content of the conference. In some cases, the modification may include distorting or suspending the audio content of the conference. For example, the modification may include blurring or suspending the video content of the conference and distorting or suspending the audio content of the conference, such as to cause all media of the conference to be modified. In another example, the modification may include blurring or suspending the video content of the conference or distorting or suspending the audio content of the conference, such as to cause only some, and thus not all, media of the conference to be modified.

To modify the media output at the device 504, the conference security software 514 may indicate the determination of the unauthorized person to the client application 510. The client application 510 may then process the indication to determine the modification to be performed. For example, the client application 510 may filter the media (e.g., using a video blurring and/or audio distorting filter) or to selectively disable the output of the media at the output components 520 of the device 504 (e.g., one or more speakers and/or one or more displays integrated within or otherwise coupled to the device 504). Alternatively, to modify the media output at the device 504, the conference security software 514 may determine the modification to be performed and transmit instructions for the modification to the client application 510. The client application 510 processes the instructions from the conference security software 514 to filter the media (e.g., using a video blurring and/or audio distorting filter) or to selectively disable the output of the media at the output components 520 of the device 504. In either case, the modification of the media output at the device 504 may be automated by or using the client application 510 and thus does not involve or otherwise require a user of the device 504 to approve a proposed modification of the media. However, in some implementations, the client application 510 may prompt a user of the device 504 to approve the proposed modification before it is performed.

The conferencing software 506 can optionally transmit a message to one or more of the other devices to indicate the modification of the media output at the device 504 to conference participants using those one or more other devices 512. The message serves to alert the conference participants using those one or more other devices 512 that conference participants within the physical space 502 may not be receiving some or all of the media of the conference. In some cases, the message may indicate that the modification of the media output at the device 504 is because an unauthorized person entered the physical space 502. In some cases, the message may specifically identify the unauthorized person (e.g., based on the identifying information of the unauthorized person determined by the conference security software 514). In some cases, the message may indicate the particular manner by which the media output at the device 504 is modified. The message may, for example, be transmitted via a chat service of the conference, a push notification to client applications running on the one or more other devices 512, or the like.

The media output at the device 504 is modified until a resolution event associated with the unauthorized person is determined. The resolution event is or otherwise refers to some event, action, or occurrence which resolves the potential security issue arisen from the unauthorized person having entered the physical space 502. A resolution event may, for example, be a determination that the unauthorized person has left the physical space 502 or an authorization by one or more conference participants of the unauthorized person to access the media of the conference. The resolution event is determined by the conference security software 514. The conference security software 514 can determine a resolution event based on one or both of information obtained from the device 504 or a prompt response received from the device 504 or one or more of the other devices 512. For example, the information obtained from the device 504 used to determine the resolution event may correspond to a video stream captured by the camera 518 after the modification of the media output at the device 504. The video stream may be transmitted to the conferencing software 506 by the client application 510 and processed by the conference security software 514 to determine that the unauthorized person is no longer in the physical space 502. For example, the video stream can be processed as described above using facial detection and recognition using the known person data store 516 and the list of authorized participants for the conference. In some cases, such as where there are other cameras in the physical space 502, video streams can be processed from some or all of those other cameras to verify that the unauthorized person has left the physical space 502 (e.g., instead of simply having moved outside of a field of view of the camera 518). In another example, the conference security software 514, based on the determination that the unauthorized person has entered the physical space 502, may transmit a prompt to one or more devices connected to the conference (e.g., the device 504 and/or one or more of the other devices 512) requesting users of those devices to indicate whether to authorize the unauthorized person to access media of the conference. In some cases, an authorization from any participant via a prompt response will result in a resolution event in which the unauthorized person becomes authorized to access the media of the conference. In some cases, a resolution event in which the unauthorized person becomes authorized to access the media of the conference may be limited to prompt responses from a priority participant (e.g., a host of the conference, a stakeholder, or another participant designated as having priority status). In some cases, a resolution event in which the unauthorized person becomes authorized to access the media of the conference may occur only where all conference participants unanimously authorize the unauthorized person.

In some implementations in which the resolution event is based on an authorization by one or more conference participants via a prompt response, the prompt transmitted to the devices of the one or more conference participants may include options other than “authorize” and “do not authorize.” For example, the prompt may include options for allowing a conference participant to authorize the unauthorized person for a limited portion of the current conference only, for the entire current conference only, or for the current conference and one or more future conferences (e.g., where the conference is a recurring conference). In some implementations, a message may be transmitted to the one or more other devices 512 based on the determination of the resolution event associated with the unauthorized person or based on the restoration of the media at the device 504 to notify conference participants using those one or more other devices 512 that the conference participants using the device 504 are once again receiving the media of the conference in its original (i.e., unmodified) form.

The conferencing software 506 generates an audit log for the conference, either in real-time or after the conference ends. An audit log includes information associated with the conference, such as which conference participants connected or disconnected at what times, which media was output to conference participants at what times, which conference participants provided that media at what times, and the like. The audit log for a conference may be reviewed after the conference ends to understand what events occurred during the conference, such as in relation to an unauthorized person entering the physical space 502. For example, an audit log generated based on a conference in which an unauthorized person is determined to have entered the physical space 502 may include information such as identifying information of the unauthorized person, times at which the unauthorized person was determined to have entered the physical space 502 and left the physical space 502 or became authorized to access the media of the conference (as applicable), identifying information for one or more conference participants who authorized the unauthorized person (as applicable), information associated with the media that was output during the time in which the unauthorized person was determined to have been within or outside of the physical space 502, information indicating the manner by which the media was modified during the conference, and/or identifying information for devices within the physical space 502 at which output of the media in an unmodified form continued (as applicable). Thus, in some cases, an audit log for the conference may indicate the specific media that would have been exposed to the unauthorized person but for the modification of the media output at the device 504. The conferencing software 506 may store the audit log for the conference within an audit log data store 522 for later access.

In some implementations, the physical space 502 includes one or more sensors 524 located within or external to the physical space 502. For example, the sensors 524 may include one or more cameras separate from the camera 518 (i.e., cameras not integrated within or otherwise coupled to the device 504), radio frequency id (RFID) readers, fingerprint scanners, and/or iris scanners. The sensors 524 may be used to collect information usable to identify the unauthorized person, for example, in addition to or instead of the facial recognition process disclosed herein. For example, an unauthorized person may be required to scan their employee badge which includes a RFID tag to gain entry into the physical space 502. An RFID reader located outside the physical space 502 can scan the employee badge via the RFID tag to obtain information uniquely associated with the unauthorized person (e.g., an alphanumeric code corresponding to the RFID tag). The RFID reader can then either transmit that information to the conferencing software 506 for the conference security software 514 to use to query the known person data store 516 for corresponding identifying information of the unauthorized person, or the RFID reader can itself directly query the known person data store 516 for such corresponding information. In another example, a camera (e.g., a security camera) located outside of the physical space 502 can capture a video stream depicting the unauthorized person as being outside the physical space 502 (e.g., within a position at which media of the conference may potentially be perceptible to them) for a threshold duration (e.g., two minutes). The camera can then transmit the video stream and an indication of the detection of the unauthorized person for the threshold duration to the conferencing software 506 for the conference security software 514 to use to query the known person data store 516 for corresponding identifying information of the unauthorized person, or the RFID reader can itself directly query the known person data store 516 for such corresponding information. In some implementations, one or more of the sensors 524 may be integrated into the device 504.

In some cases, the device 504 may be one of multiple devices located within the physical space 502 and connected to the conference implemented by the conferencing software 506. In some implementations, modifying the media may include modifying the media output at all of the devices within the physical space 502. For example, a security configuration may be defined (e.g., specific to the conference, the conference participants, a premises at which the physical space 502 is located, or a software platform customer associated with the physical space 502) to cause all devices within the physical space 502 to output modified media based on a determination, using information obtained from one or more of the devices, that an unauthorized person has entered the physical space 502 during the conference. In some implementations, modifying the media may include modifying the media output at some, but not all, of the devices within the physical space 502, or it may include differently modifying the media at different ones of the devices within the physical space 502. For example, the modification of the media may only be performed for the specific one or more devices from which information used to determine that the unauthorized person has entered the physical space 502 was obtained. In another example, audio content may be distorted or suspended at all of the devices within the physical space 502 and video content may be blurred or suspended at only those devices from which information used to determine that the unauthorized person has entered the physical space 502 was obtained.

In some implementations, some or all of the functionality of the conference security software 514 may exist outside of the conference security software 514 and/or the conferencing software 506 may exclude the conference security software 514 while still including the functionality thereof. In some such implementations, the conference security software 514 may be included in the client application 510. For example, rather than the determination that the unauthorized person has entered the physical space 502 or the determination of the resolution event being performed at the server device 508, those determinations, and potentially other aspects of the conference security software 514 as disclosed herein, may instead be performed at the device 504 (e.g., via the client application 510). In some such implementations, the conference security software included in the client application 510 may be or refer to client-side conference security software and the conference security software 514 may be or refer to server-side conference security software. For example, the client-side and server-side conference security software may communicate with one another to perform operations for preventing exposure of media of a conference to an unauthorized person.

In some implementations, one or more exposure prevention mechanisms separate from the modification of media output at the device 504 may be triggered based on the processing performed by the conference security software 514. For example, the exposure prevention mechanisms may include white noise machines that output white noise sounds to distort or render imperceptible audio of the conference from areas within the physical space 502 or outside of the physical space 502 or privacy glass components that cause glass walls and/or windows of the physical space 502 to become opaque in order to prevent video content of the conference to be imperceptible to persons outside of the physical space 502. In some such implementations, the triggering of an exposure prevention mechanism may be based on manual selection by a conference participant within the physical space 502. For example, the conference security software 514 may transmit a prompt to the client application 510 asking if the user of the device 504 would like to engage the exposure prevention mechanism, and the exposure prevention mechanism may accordingly be engaged or not based on a response to that prompt. In some such implementations, the triggering of an exposure prevention mechanism may be automated based on content of the media of the conference. For example, a real-time transcription service used for the conference may process real-time audio content of the conference and/or a machine vision service used for the conference may process real-time video content of the conference to determine that such content is confidential or otherwise sensitive (e.g., based on an audio or visual statement that the content is confidential or based on a context of a conversation or presentation item). Based on that determination, the conference security software 514 may selectively engage, without manual user intervention, the exposure prevention mechanism either for the remainder of the conference or until a determination is made (e.g., based on output of those real-time processing services) that the confidential or otherwise sensitive content is no longer being discussed or presented.

In some implementations, a summary of the modified media may be output to the device 504 or an associated device based on the determination of the resolution event associated with the unauthorized person or based on the restoration of the media at the device 504. For example, machine vision functionality enabled or otherwise available for use with the conference may monitor video content of the conference, such as slides of a slideshow presentation, during a period in which the media of the conference output at the device 504 is modified and capture still images of the video content (e.g., of individual slides). The still images may be presented for display at the device 504 after the media output at the device 504 has been restored.

In some implementations, the device 504 may be configured to connect to the conferencing software 506 for the conference based, for example, on a reservation of the physical space 502 for the conference. For example, the device 504 may be configured with authentication information (e.g., an encoded link or a username and password combination) usable to automatically cause the client application 510 to the conferencing software 506 without first requiring manual user entry of such authentication information. In some such implementations, the conference security software 514 may prohibit a conference participant other than the host or another conference participant designated with appropriate privileges from initiating the conference. For example, where a person who is neither a host nor a designated conference participant interacts with the device 504 to attempt to connect to the conference, facial recognition or other biometric processing (e.g., based on a fingerprint or iris scan) may be performed against the person to determine that the person is not the host or a designated conference participant (e.g., by comparing identifying information of the person obtained from the facial recognition or other biometric processing against the list of authorized participants for the conference). Based on that determination, the conference is not initiated. This may, for example, be performed to prevent exposure of media of the conference to the person.

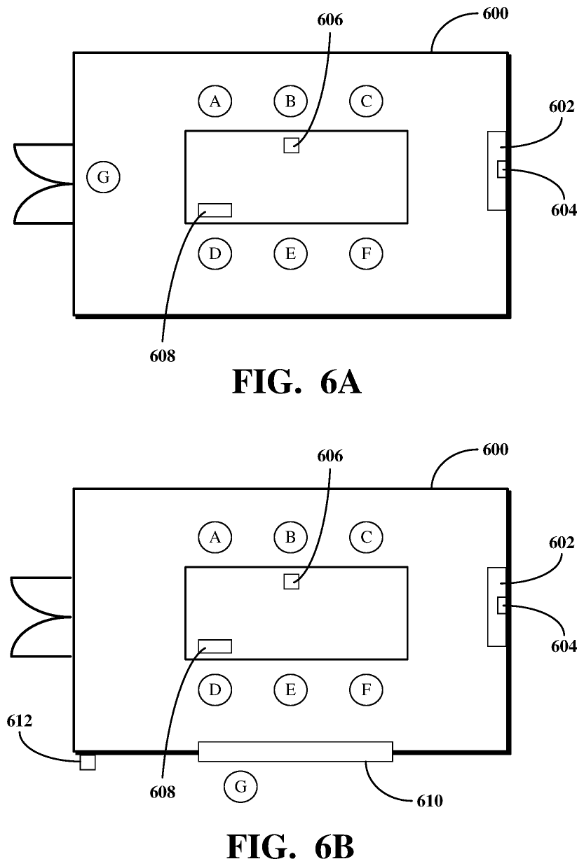

FIGS. 6A-B are illustrations of examples of physical spaces and unauthorized persons determined to have entered same. The discussion with respect to FIGS. 6A-B is to illustrate processing which may be performed by the system 500 shown in FIG. 5 with reference to example use cases with which the system 500 may be used. Referring first to FIG. 6A, a video conference is being attended by six conference participants A through F located within a conference room 600, which may, for example, be the physical space 502 shown in FIG. 5. The conference participants A through F are listed in a list of authorized participants for the video conference and are participating in the video conference using a shared conference room device 602 which includes a display, speakers, and a camera 604 (e.g., the camera 518 shown in FIG. 5). Based on its positioning, the entire conference room 600, with exception to small portions of the corners located closest to the device 602, is visible within a field of view of the camera 604. The conference participant B has their own personal device 606 in front of them, and the conference participant D has their own personal device 608 in front of them.

At some point during the video conference, a person G enters the conference room 600. The video stream captured by the camera 604 depicts the person G and is processed to determine that the person G is not included in the list of authorized participants. Thus, a determination is made that the person G is an unauthorized person who has entered the conference room 600 during the video conference. Based on this determination, video content of the conference is blurred or suspended at the display of the device 602 and audio content of the conference is distorted or suspended at the speakers of the device 602. Further based on the determination, audio content of the conference is distorted or suspended at the devices 606 and 608. However, because the person G is not detected within video streams captured by cameras of the devices 606 and 608, an implication is made that the person G cannot see the video content output at the displays of the devices 606 and 608. As such, the video content of the conference may remain output in an unmodified form at the devices 606 and 608. Alternatively, for security purposes, the video content of the conference may also be blurred or suspended at the devices 606 and 608.

Based on the determination that the person G is an unauthorized person who has entered the conference room 600, and after the modification of the media output at the devices 602, 606, and 608, the devices 602, 606, and 608, as well as devices of remote participants connected to the conference other than from the conference room 600, receive a prompt and asking whether to authorize the person G to access the media of the conference. The person G may, for example, be a work colleague of the conference participants A through F, in which case those conference participants may respond to one or more of the prompts received at the devices 602, 606, and 608 indicating to authorize the person G. In such a case, a resolution event may be determined based on those prompt responses. Upon the resolution event, the media output at the devices 602, 606, and 608 is restored. Alternatively, the person G may be a caterer who is delivering lunch to the conference participants A through F, in which case those conference participants may respond to the one or more of the prompts indicating not to authorize the person G. In such a case, a resolution event may eventually be determined once the person G is determined to have left the conference room 600, such as based on the further processing of the video stream captured by the camera 604 no longer indicating a detection of a face of the person G. Upon the resolution event, the media output at the devices 602, 606, and 608 is restored. Information associated with the detection of the person G, the modification of the media, and the resolution event may be stored in an audit log of the video conference.

Referring next to FIG. 6B, the same conference participants A through F are shown within the same conference room 600 and using the same devices 602, 606, and 608 as are shown and described with respect to FIG. 6A. Here, however, at some point during the video conference, the person G is detected to have been standing right outside a window 610 of the conference room 600 for more than a threshold duration by processing a video stream captured by a security camera 612 located outside of the conference room 600. Based on that detection of the person G for more than a threshold duration and a determination based on identifying information of the person G identified based on facial recognition processing performed against the video stream captured by the security camera 612, the person G is determined as an unauthorized person who has entered the conference room 600 (e.g., is within a position from which media of the conference output within the conference room 600 may be perceptible). In some cases, the person G may also or instead be detected by processing a video stream captured by a front-facing camera of the device 608 and/or a video stream captured by a rear-facing camera of the device 606.

Based on the determination that the person G is an unauthorized person who has entered the conference room 600, video content of the conference is blurred or suspended at the displays of the devices 602, 606, and 608 and audio content of the conference is distorted or suspended at the speakers of the devices 602, 606, and 608. Alternatively, where the conference room 600 is sound proofed (e.g., as may be noted in record of a data store), the audio content may remain unmodified at each of the devices 602, 606, and 608. However, because the person G is not detected within a video stream of a front-facing camera of the device 606, an implication is made that the person G cannot see the video content output at the display of the devices 606. As such, the video content of the conference may remain output in an unmodified form at the device 606. In some cases, an exposure prevention mechanism such as a privacy glass component of the window 610 may be triggered based on the determination that the person G is an unauthorized person who has entered the conference room 600.

Identifying information for the person G can be included within a prompt transmitted to the devices 602, 606, and 608, as well as one or more remote participant devices, asking whether or not to authorize the person G to access media of the video conference. Because the person G is eavesdropping for an extended period of time rather than asking to join the video conference, the conference participants A through F believe it is not necessary to authorize the person G to access the media of the video conference. The media remains output at the devices 602, 606, and 608 in a modified form until a resolution event in which the person G is determined, based on the video stream of the security camera 612 and/or of one or more of the devices 606 or 608, to have left the conference room 600 (e.g., the area outside the window 610). Upon the resolution event, the media output at the devices 602, 606, and 608 is restored. Information associated with the detection of the person G, the modification of the media, and the resolution event may be stored in an audit log of the video conference.

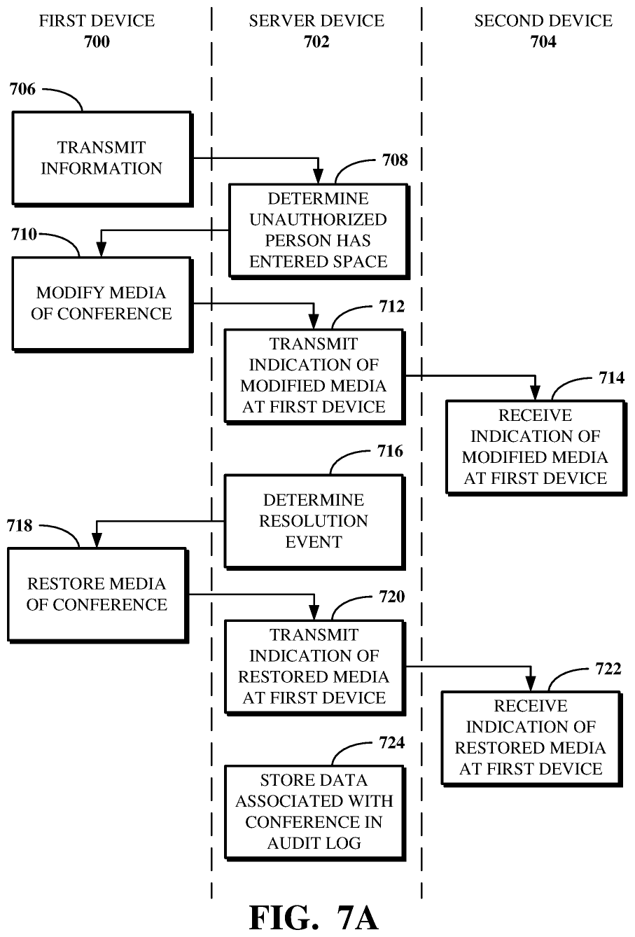

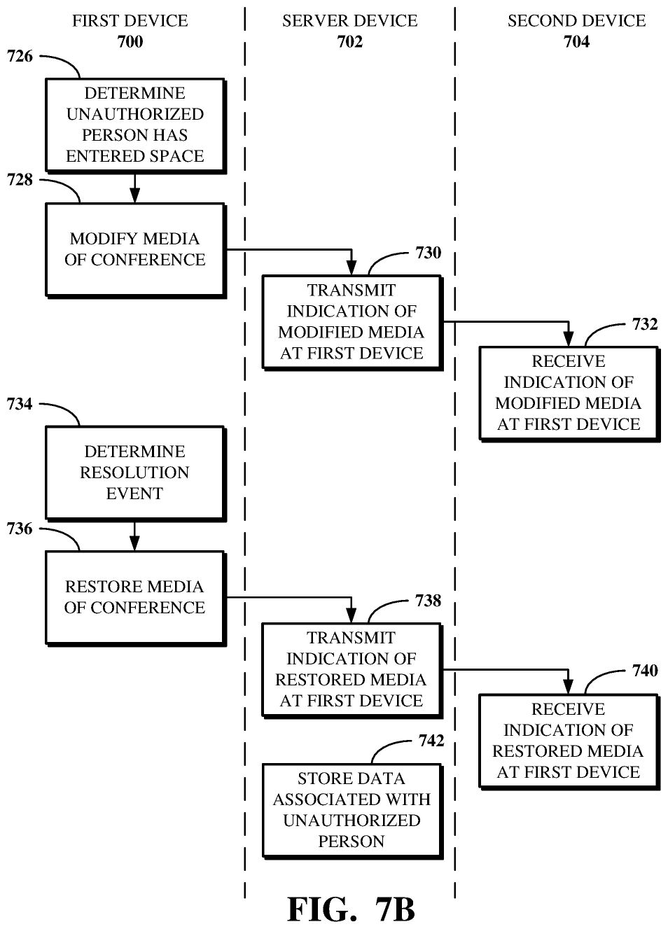

FIGS. 7A-B are swim lane diagrams of example sequences of operations performed for preventing exposure of media of a conference to an unauthorized person. The sequences of operations are described as being between a first device 700, a server device 702, and a second device 704. The first device 700 is connected to a conference and located within a physical space, and may, for example, be the device 504 shown in FIG. 5. The server device 702 includes conferencing software for implementing the conference and may, for example, be the server device 508 shown in FIG. 5. The second device 704 is connected to the conference and located external to the physical space, and may, for example, be one of the one or more other devices 512 shown in FIG. 5.

Referring first to FIG. 7A, a sequence of operations involving conference security software located at the server device 702 is shown. At 706, information is transmitted from the first device 700 to the server device 702. The information may, for example, include a video stream captured by a camera of the first device 700. At 708, a determination is made at the server device 702 that an unauthorized person has entered the physical space. At 710, instructions are transmitted from the server device 702 to the first device 700 to cause a modification of media of the conference output at the first device 700. At 712, based on the modification of the media output at the first device 700, the server device 702 transmits an indication of the modification of the media at the first device 700 to the second device 704. At 714, the second device 704 receives the indication of the modification of the media at the first device 700. At 716, at some point after the modification of the media at the first device 700 begins, a resolution event associated with the unauthorized person is determined at the server device 702. At 718, the modified media is restored at the first device 700, for example, based on instructions transmitted from the server device 702 to the first device 700 based on the resolution event. At 720, an indication that the modified media has been restored at the first device 700 is transmitted from the server device 702 to the second device 704. At 722, the second device 722 receives the indication that the modified media has been restored at the first device 700. At 724, at some point after the restoration of the modified media at the first device 700, data associated with the conference (e.g., indicative of the unauthorized person and the conference media presented or otherwise output during the period in which the unauthorized person was present) is stored within an audit log associated with the conference.

Referring next to FIG. 7B, a sequence of operations involving conference security software located at the first device 700 is shown. At 726, a determination is made at the first device 700 that an unauthorized person has entered the physical space, for example, based on the processing of a video stream captured by a camera of the first device 700. At 728, media of the conference output at the first device 700 is modified at the first device 700 based on the determination of the unauthorized person. At 730, based on the modification of the media output at the first device 700, the server device 702 transmits an indication of the modification of the media at the first device 700 to the second device 704. At 732, the second device 704 receives the indication of the modification of the media at the first device 700. At 734, at some point after the modification of the media at the first device 700 begins, a resolution event associated with the unauthorized person is determined at the first device 700. At 736, the modified media is restored at the first device 700. At 738, an indication that the modified media has been restored at the first device 700 is transmitted from the server device 702 to the second device 704. At 740, the second device 722 receives the indication that the modified media has been restored at the first device 700. At 742, at some point after the restoration of the modified media at the first device 700, data associated with the conference (e.g., indicative of the unauthorized person and the conference media presented or otherwise output during the period in which the unauthorized person was present) is stored within an audit log associated with the conference.

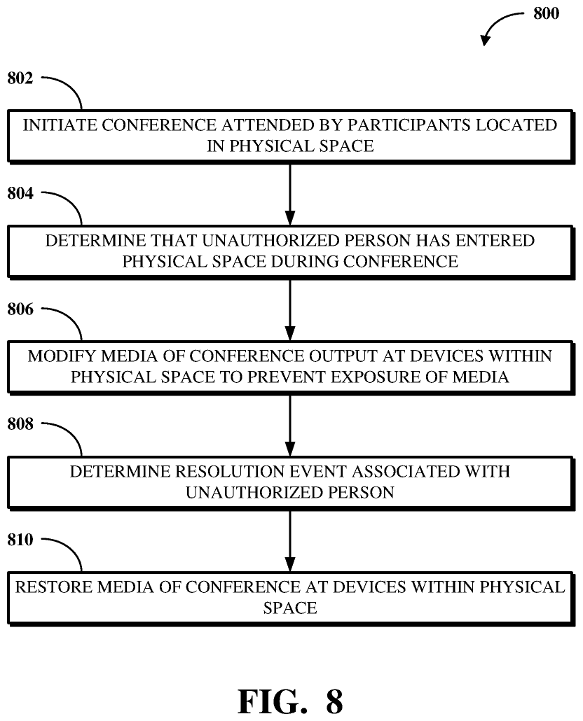

To further describe some implementations in greater detail, reference is next made to examples of techniques which may be performed by or using a system for preventing exposure of media of a conference to an unauthorized person. FIG. 8 is a flowchart of an example of a technique 800 for preventing exposure of media of a conference to an unauthorized person. The technique 800 can be executed using computing devices, such as the systems, hardware, and software described with respect to FIGS. 1-7B. The technique 800 can be performed, for example, by executing a machine-readable program or other computer-executable instructions, such as routines, instructions, programs, or other code. The steps, or operations, of the technique 800, or another technique, method, process, or algorithm described in connection with the implementations disclosed herein can be implemented directly in hardware, firmware, software executed by hardware, circuitry, or a combination thereof.

For simplicity of explanation, the technique 800 is depicted and described herein as a series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

At 802, a conference attended by one or more participants located within a physical space is initiated. The conference may, for example, be a video conference attended by one or more conference participants located within the physical space and one or more conference participants located external to the physical space. In some cases, access to the video conference by the one or more participants may be authenticated using a list of authorized participants for the conference, such as based on facial recognition processing to detect faces of the participants, querying of a known person data store for pictures matching the detected faces, determining identifying information associated with the matching pictures, and comparing the identifying information against the list of authorized participants.

At 804, a determination is made during the conference that an unauthorized person has entered the physical space. Determining during the conference that the unauthorized person has entered the physical space may, for example, include performing facial recognition against a video stream obtained from the one or more devices to identify the unauthorized person and determining that a list of authorized participants for the conference omits the unauthorized person. For example, determining during the conference that the unauthorized person has entered the physical space may include determining identifying information associated with the unauthorized person and determining that the list of authorized participants for the conference omits the unauthorized person. In some cases, determining during the conference that the unauthorized person has entered the physical space may include detecting the unauthorized person within a perceptible media range external to the physical space. For example, determining during the conference that the unauthorized person has entered the physical space may include detecting, within a video stream obtained from a camera having a field of view including a window of the physical space, the unauthorized person through the window of the physical space or next to the window of the physical space.

At 806, media of the conference output at one or more devices located within the physical space is modified to prevent exposure of the media to the unauthorized person. In some cases, modifying the media of the conference can include blurring video content of the conference at the one or more devices and distorting audio content of the video conference at the one or more devices. In some cases, modifying the media of the conference can include blurring video content of the conference at the one or more devices without distorting audio content of the conference at the one or more devices. In some cases, modifying the media of the conference can include distorting audio content of the conference at the one or more devices without blurring video content of the conference at the one or more devices. Alternatively, modifying the media can include suspending the media rather than blurring or distorting it. Other manners of filtering the media beyond blurring and filtering are also possible. Where the only media of the conference is audio media, modifying the media of the conference output at the one or more devices includes modifying the output of the audio media at the one or more devices. Where the only media of the conference is video media, modifying the media of the conference output at the one or more devices includes modifying the output of the video media at the one or more devices. The media is output in an original state at one or more remote devices located external to the physical space while the modified media is output at the one or more devices located within the physical space.

At 808, a resolution event associated with the unauthorized person is determined. The resolution event may correspond to the unauthorized person being granted access to the conference by a participant of the one or more participants or to the unauthorized person leaving the physical space. For example, responsive to determining that the unauthorized person has entered the physical space, participants one or more devices connected to the conference may be prompted to indicate whether to authorize the unauthorized person to access the media of the conference. In some cases, such as where identifying information associated with the unauthorized person is determined (e.g., based on facial recognition performed against a video stream obtained from the one or more devices), the identifying information may be output to one or more of the devices connected to the conference, such as within the prompt. In another example, a video stream obtained from one or more of the devices connected to the conference may be processed to determine that the unauthorized person has left the physical space.

At 810, based on the resolution event, the media of the conference output at the one or more devices located within the physical space is restored. Restoring the media output at the one or more devices includes resuming output of the media in an original form, for example, by removing filters used to blur or distort the media.

In some implementations, responsive to determining that the unauthorized person has entered the physical space, the technique 800 may include transmitting a message to one or more remote participants of the conference located external to the physical space to indicate a modification of the media of the conference at the one or more devices.

In some implementations, the technique 800 may include triggering an exposure prevention mechanism to prevent access to the media of the video conference from within the perceptible media range, such as where the unauthorized person is detected within a perceptible media range external to the physical space.

In some implementations, the technique 800 may include recording, within an audit log associated with the conference, data indicative of the unauthorized person and the modification of the media of the video conference. For example, recording the data within the audit log may include storing data indicative of one or more of the unauthorized person, the media modified based on the determination of the unauthorized person, or the resolution event in connection with a recording, an audit log, or other data associated with the conference. In another example, recording the data within the audit log may include generating record data indicating a timestamp at which the determination that the unauthorized person has entered the physical space is made and storing the record data in connection with a recording of the conference.

In some implementations, the technique 800 may omit determining a resolution event associated with the unauthorized person and restoring the media of the conference output at the one or more devices based on a resolution event. For example, where a resolution event is not determined, such as where the unauthorized person is not authorized to access the conference or is not determined to have left the physical space before the one or more devices located within the physical space disconnect from the conference, the media of the conference output at the one or more devices located within the physical space may not be restored. In such a case, the technique 800 may conclude with the modification of the media or with determining that the one or more devices have disconnected from the conference.

The implementations of this disclosure correspond to methods, non-transitory computer readable media, apparatuses, systems, devices, and the like. In some implementations, a method comprises determining, during a video conference attended by one or more participants located within a physical space, that an unauthorized person has entered the physical space; modifying media of the video conference output at one or more devices within the physical space to prevent exposure of the media to the unauthorized person; and restoring the media of the video conference at the one or more devices based on a resolution event associated with the unauthorized person. In some implementations, a non-transitory computer readable medium stores instructions operable to cause one or more processors to perform operations comprising determining, during a video conference attended by one or more participants located within a physical space, that an unauthorized person has entered the physical space; modifying media of the video conference output at one or more devices within the physical space to prevent exposure of the media to the unauthorized person; and restoring the media of the video conference at the one or more devices based on a resolution event associated with the unauthorized person. In some implementations, an apparatus comprises a memory and a processor configured to execute instructions stored in the memory to determine, during a video conference attended by one or more participants located within a physical space, that an unauthorized person has entered the physical space; modify media of the video conference output at one or more devices within the physical space to prevent exposure of the media to the unauthorized person; and restore the media of the video conference at the one or more devices based on a resolution event associated with the unauthorized person.

In some implementations of the method, non-transitory computer readable medium, or apparatus, modifying the media of the video conference comprises blurring video content of the video conference, and distorting audio content of the video conference.

In some implementations of the method, non-transitory computer readable medium, or apparatus, determining that the unauthorized person has entered the physical space comprises performing facial recognition against a video stream obtained from the one or more devices to identify the unauthorized person; and determining that a list of authorized participants for the video conference omits the unauthorized person.

In some implementations of the method, non-transitory computer readable medium, or apparatus, the resolution event corresponds to the unauthorized person being granted access to the video conference by a participant of the one or more participants, and the method comprises, the operations comprise, and the processor is configured to execute the instructions for, responsive to determining that the unauthorized person has entered the physical space, prompting the participant at a device of the one or more devices to indicate whether to grant the unauthorized person access to the video conference.

In some implementations of the method, non-transitory computer readable medium, or apparatus, the resolution event corresponds to the unauthorized person leaving the physical space, and the method comprises, the operations comprise, and the processor is configured to execute the instructions for processing a video stream obtained from the one or more devices to determine that the unauthorized person has left the physical space.

In some implementations of the method, non-transitory computer readable medium, or apparatus, the method comprises, the operations comprise, and the processor is configured to execute the instructions for, responsive to determining that the unauthorized person has entered the physical space, transmitting a message to one or more remote participants of the video conference located external to the physical space to indicate a modification of the media of the video conference at the one or more devices.

In some implementations of the method, non-transitory computer readable medium, or apparatus, the method comprises, the operations comprise, and the processor is configured to execute the instructions for recording, within an audit log associated with the video conference, data indicative of the unauthorized person and the modification of the media of the video conference.

In some implementations of the method, non-transitory computer readable medium, or apparatus, the method comprises, the operations comprise, and the processor is configured to execute the instructions for authenticating access to the video conference by the one or more participants using a list of authorized participants for the video conference.

In some implementations of the method, non-transitory computer readable medium, or apparatus, determining that the unauthorized person has entered the physical space comprises detecting the unauthorized person within a perceptible media range of the physical space.

In some implementations of the method, non-transitory computer readable medium, or apparatus, determining that the unauthorized person has entered the physical space comprises determining identifying information associated with the unauthorized person, and determining that a list of authorized participants for the video conference omits the unauthorized person.

In some implementations of the method, non-transitory computer readable medium, or apparatus, restoring the media of the video conference at the one or more devices comprises determining that the unauthorized person has left the physical space.

In some implementations of the method, non-transitory computer readable medium, or apparatus, the method comprises, the operations comprise, and the processor is configured to execute the instructions for generating record data indicating a timestamp at which the determination that the unauthorized person has entered the physical space is made, and storing the record data in connection with a recording of the video conference.

In some implementations of the method, non-transitory computer readable medium, or apparatus, determining that the unauthorized person has entered the physical space comprises detecting the unauthorized person within a perceptible media range external to the physical space, and triggering an exposure prevention mechanism to prevent access to the media of the video conference from within the perceptible media range.

In some implementations of the method, non-transitory computer readable medium, or apparatus, modifying the media of the video conference comprises blurring video content of the video conference.

In some implementations of the method, non-transitory computer readable medium, or apparatus, the method comprises, the operations comprise, and the processor is configured to execute the instructions for prompting the one or more participants and one or more remote participants participating in the video conference from one or more locations external to the physical space to authorize the unauthorized person to access the media of the video conference.

In some implementations of the method, non-transitory computer readable medium, or apparatus, the media is output in an original state at one or more remote devices located external to the physical space while the modified media is output at the one or more devices.

In some implementations of the method, non-transitory computer readable medium, or apparatus, determining that the unauthorized person has entered the physical space comprises detecting, within a video stream obtained from a camera having a field of view including a window of the physical space, the unauthorized person through the window of the physical space.

In some implementations of the method, non-transitory computer readable medium, or apparatus, determining that the unauthorized person has entered the physical space comprises performing facial recognition against a video stream obtained from the one or more devices to determine identifying information associated with the unauthorized person, and output the identifying information to the one or more devices.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
determining, during a video conference attended by one or more participants located within a physical space, that an unauthorized person has entered the physical space;
modifying media of the video conference output at one or more devices within the physical space to prevent exposure of the media to the unauthorized person; and
restoring the media of the video conference at the one or more devices based on a resolution event associated with the unauthorized person.

2. The method of claim 1, wherein modifying the media of the video conference comprises:
blurring video content of the video conference; and
distorting audio content of the video conference.

3. The method of claim 1, wherein determining that the unauthorized person has entered the physical space comprises:
performing facial recognition against a video stream obtained from the one or more devices to identify the unauthorized person; and
determining that a list of authorized participants for the video conference omits the unauthorized person.

4. The method of claim 1, wherein the resolution event corresponds to the unauthorized person being granted access to the video conference by a participant of the one or more participants, the method comprising:
responsive to determining that the unauthorized person has entered the physical space, prompting the participant at a device of the one or more devices to indicate whether to grant the unauthorized person access to the video conference.

5. The method of claim 1, wherein the resolution event corresponds to the unauthorized person leaving the physical space, the method comprising:
processing a video stream obtained from the one or more devices to determine that the unauthorized person has left the physical space.

6. The method of claim 1, comprising:
responsive to determining that the unauthorized person has entered the physical space, transmitting a message to one or more remote participants of the video conference located external to the physical space to indicate a modification of the media of the video conference at the one or more devices.

7. The method of claim 1, comprising:
recording, within an audit log associated with the video conference, data indicative of the unauthorized person and the modification of the media of the video conference.

8. The method of claim 1, comprising:
authenticating access to the video conference by the one or more participants using a list of authorized participants for the video conference.

9. The method of claim 1, wherein determining that the unauthorized person has entered the physical space comprises:
detecting the unauthorized person within a perceptible media range of the physical space.

10. A non-transitory computer readable medium storing instructions operable to cause one or more processors to perform operations comprising:
determining, during a video conference attended by one or more participants located within a physical space, that an unauthorized person has entered the physical space;
modifying media of the video conference output at one or more devices within the physical space to prevent exposure of the media to the unauthorized person; and
restoring the media of the video conference at the one or more devices based on a resolution event associated with the unauthorized person.

11. The non-transitory computer readable medium of claim 10, wherein the operations for determining that the unauthorized person has entered the physical space comprise:
determining identifying information associated with the unauthorized person; and
determining that a list of authorized participants for the video conference omits the unauthorized person.

12. The non-transitory computer readable medium of claim 10, wherein the operations for restoring the media of the video conference at the one or more devices comprise:
determining that the unauthorized person has left the physical space.

13. The non-transitory computer readable medium of claim 10, the operations comprising:
generating record data indicating a timestamp at which the determination that the unauthorized person has entered the physical space is made; and
storing the record data in connection with a recording of the video conference.

14. The non-transitory computer readable medium of claim 10, wherein the operations for determining that the unauthorized person has entered the physical space comprise:
detecting the unauthorized person within a perceptible media range external to the physical space; and
triggering an exposure prevention mechanism to prevent access to the media of the video conference from within the perceptible media range.

15. An apparatus, comprising:
a memory; and
a processor configured to execute instructions stored in the memory to:
determine, during a video conference attended by one or more participants located within a physical space, that an unauthorized person has entered the physical space;
modify media of the video conference output at one or more devices within the physical space to prevent exposure of the media to the unauthorized person; and
restore the media of the video conference at the one or more devices based on a resolution event associated with the unauthorized person.

16. The apparatus of claim 15, wherein, to modify the media of the video conference, the processor is configured to execute the instructions to:
blur video content of the video conference.

17. The apparatus of claim 15, wherein the processor is configured to execute the instructions to:
prompt the one or more participants and one or more remote participants participating in the video conference from one or more locations external to the physical space to authorize the unauthorized person to access the media of the video conference.

18. The apparatus of claim 15, wherein the media is output in an original state at one or more remote devices located external to the physical space while the modified media is output at the one or more devices.

19. The apparatus of claim 15, wherein, to determine that the unauthorized person has entered the physical space, the processor is configured to execute the instructions to:
detect, within a video stream obtained from a camera having a field of view including a window of the physical space, the unauthorized person through the window of the physical space.

20. The apparatus of claim 15, wherein, to determine that the unauthorized person has entered the physical space, the processor is configured to execute the instructions to:
perform facial recognition against a video stream obtained from the one or more devices to determine identifying information associated with the unauthorized person; and
output the identifying information to the one or more devices.
